(19) United States
(12) Patent Application Publication
(10) Pub. No.: US 2015/0032548 A1
(43) Pub. Date: Jan. 29, 2015

(54) SYSTEM AND METHOD FOR ENHANCING OEM PARTS SHOPPING

(71) Applicants: Ari Shapiro, Discovery Bay, CA (US); Darren Endo, Walnut Creek, CA (US); Khushwant Singh, Dublin, CA (US); David Dell' Aquila, San Jose, CA (US); Alex Yra, San Jose, CA (US)

(72) Inventors: Ari Shapiro, Discovery Bay, CA (US); Darren Endo, Walnut Creek, CA (US); Khushwant Singh, Dublin, CA (US); David Dell' Aquila, San Jose, CA (US); Alex Yra, San Jose, CA (US)

(21) Appl. No.: 14/143,286

(22) Filed: Dec. 30, 2013

Related U.S. Application Data
(60) Provisional application No. 61/858,980, filed on Jul. 26, 2013.

(51) Int. Cl. G06Q 30/06; G06Q 30/02

(52) U.S. Cl. CPC G06Q 30/0643; G06Q 30/0633; G06Q 30/0269
USPC 705/14.66; 705/27.2; 705/26.8

(57) ABSTRACT

A system and method for enhancing OEM parts shopping are provided. In example embodiments, a user interface presents a diagram of a product to a user on which the user drills down into to view one or more schematic from the schematics database. A selection of a portion of the product displayed on the user interface is received. A schematic corresponding to the selected portion on the user interface is presented. The schematic indicates selectable items. A selection of an item of the selectable items on the schematic is received. An option to purchase the selected item is presented in response to the selection of the item.

### CROSS REFERENCE TO RELATED APPLICATION

The present application claims the priority benefit of U.S. Provisional Patent Application Ser. No. 61/858,980 filed on Jul. 26, 2013 and entitled “System and Method for Enhancing OEM Parts Shopping,” which is incorporated herein by reference.

### FIELD

The present disclosure relates generally to online shopping and, in a specific example embodiment, to enhancing an original equipment manufacturer (OEM) parts shopping experience.

### BACKGROUND

Typically, a buyer may shop for OEM parts by searching for the name of the part for their particular make, model, and year. However, this may be problematic if the buyer does not know the specific name of the part that the buyer is interested in.

### BRIEF DESCRIPTION OF DRAWINGS

Various ones of the appended drawings merely illustrate example embodiments of the present invention and cannot be considered as limiting its scope.

FIG. 1 is a block diagram illustrating an example embodiment of a network architecture of a system used to provide cross-border transaction buying assistance.

FIG. 2 is a block diagram illustrating an example embodiment of a publication system.

FIG. 3 is an example diagram of a parts engine of the publication system.

FIG. 4 is an example screenshot of part of a seller parts form.

FIGS. 5A-5L are screenshots of example buying scenarios.

FIGS. 6A and 6B are flow diagrams of an example method for enhancing OEM parts shopping.

FIG. 7 is a simplified block diagram of a machine in an example form of a computing system within which a set of instructions for causing the machine to perform any one or more of the methodologies discussed herein may be executed.

### DETAILED DESCRIPTION

The description that follows includes systems, methods, techniques, instruction sequences, and computing machine program products that embody illustrative embodiments of the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

Example embodiments described herein provide systems and methods for enhancing original equipment manufacturer (OEM) parts shopping. In some embodiments, a standalone application provides an enriched browsing experience on the Internet and on mobile devices. In the original equipment (OE) industry, OEM diagrams or schematics of parts are often used. However, these diagrams are static in nature. If a seller does not have a photo of a part they want to sell, the seller may use the schematic to illustrate the part. However, the part may be a small component of the overall schematic and difficult to see.

As such, example embodiments provide an interactive browsing experience that allows the seller to utilize the preexisting OEM schematics to help illustrate their products and allows a buyer to browse for a part using the OEM schematics. More specifically, a schematics database that stores schematics of items (e.g., parts) is maintained. A user interface that presents a high level diagram of a product to a user is provided. The user interface allows the user to drill down on the diagram of the product until a schematic for a particular portion of interest of the product is available from the schematics database. The schematic is presented on the user interface and indicates selectable items/parts on the schematic. A selection of an item/part on the schematic is received and an option to purchase the selected item/part, in response to the selection, is provided.

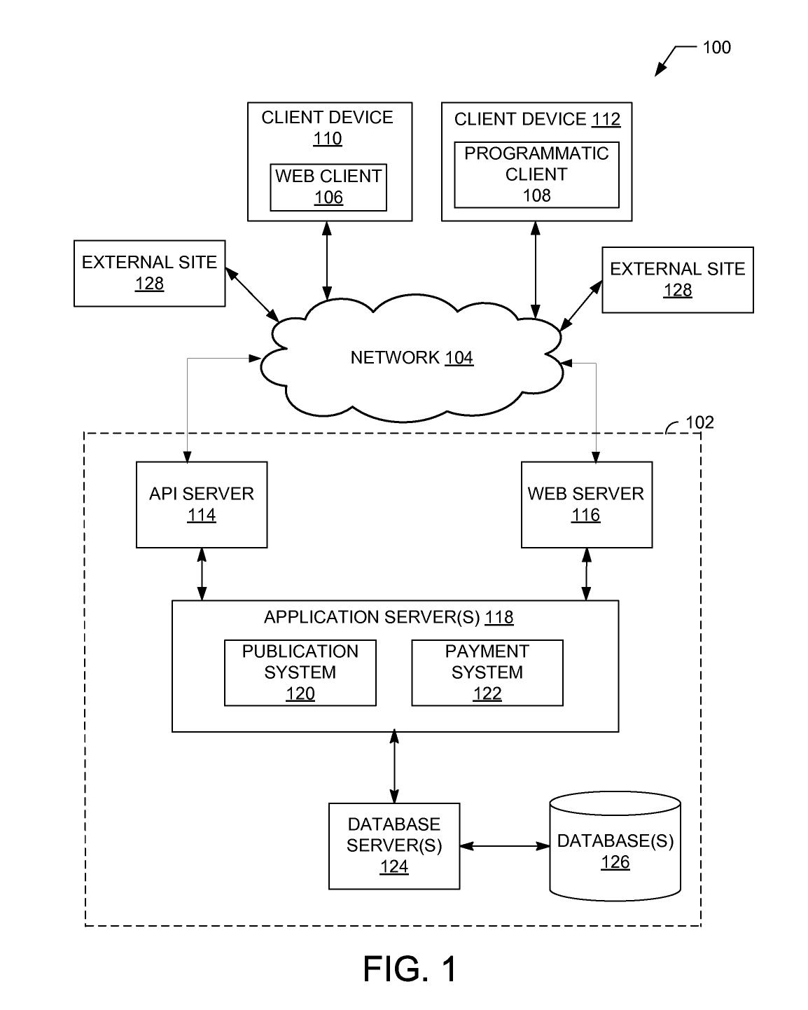

With reference to FIG. 1, an example embodiment of a high-level client-server-based network architecture 100 to enable enhanced parts shopping is shown. A networked system 102, in an example form of a network-server-side functionality, is coupled via a communication network 104 (e.g., the Internet, wireless network, cellular network, or a Wide Area Network (WAN)) to one or more client devices 110 and 112. FIG. 1 illustrates, for example, a web client 106 operating via a browser (e.g., such as the INTERNET EXPLORER® browser developed by Microsoft® Corporation of Redmond, Wash. State), and a programmatic client 108 executing on respective client devices 110 and 112.

The client devices 110 and 112 may comprise a mobile phone, desktop computer, laptop, or any other communication device that a user may utilize to access the networked system 102. In some embodiments, the client device 110 may comprise a display module (not shown) to display information (e.g., in the form of user interfaces). In further embodiments, the client device 110 may comprise one or more of a touch screen, accelerometer, camera, microphone, and Global Positioning System (GPS) device. The client devices 110 and 112 may be a device of a user, which is used to perform a search for parts within the networked system 102. In one embodiment, the networked system 102 is a network-based marketplace that manages digital goods, publishes publications comprising item listings of items available on the network-based marketplace, and manages payments for these marketplace transactions.

An Application Program Interface (API) server 114 and a web server 116 are coupled to, and provide programmatic and web interfaces respectively to, one or more application servers 118. The application servers 118 host a publication system 120 and a payment system 122, each of which may comprise one or more modules, applications, or engines, and each of which may be embodied as hardware, software, firmware, or any combination thereof. The application servers 118 are, in turn, coupled to one or more database servers 124 facilitating access to one or more information storage repositories or database(s) 126. In one embodiment, the databases 126 are storage devices that store information to be posted (e.g., publications or listings) to the publication system 120. The databases 126 may also store digital goods information in accordance with example embodiments.

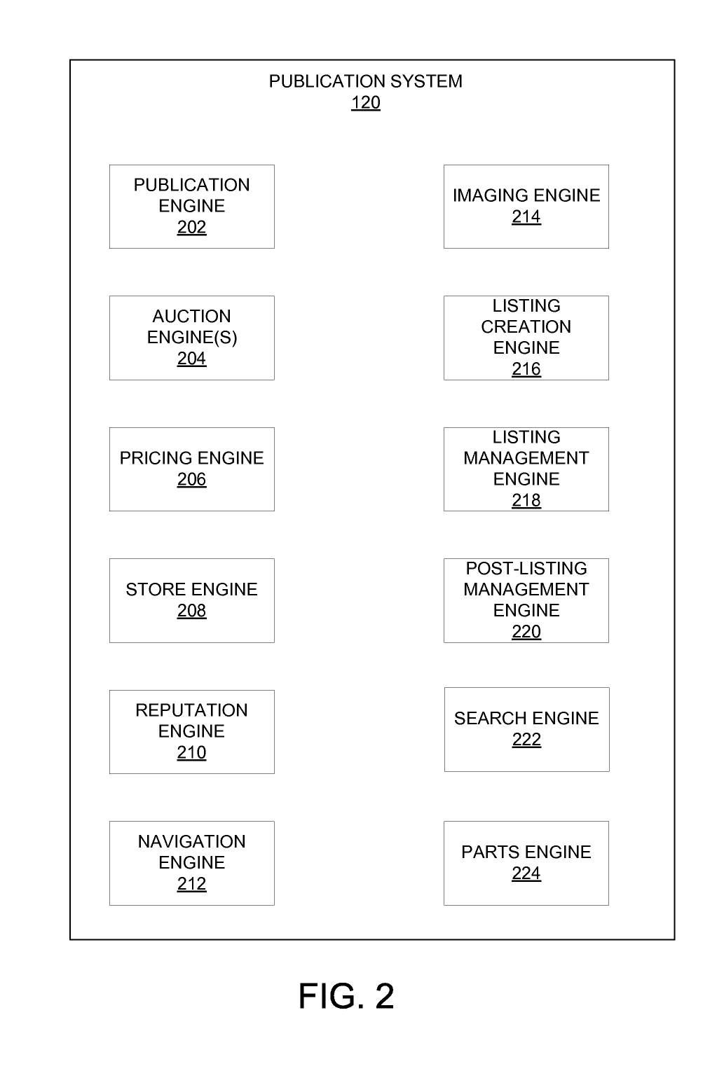

In example embodiments, the publication system 120 publishes content on a network (e.g., Internet). As such, the publication system 120 provides a number of publication and marketplace functions and services to users that access the networked system 102. The publication system 120 is discussed in more detail in connection with FIG. 2. In example embodiments, the publication system 120 is discussed in terms of a marketplace environment. However, it is noted that the publication system 120 may, in alternative embodiments, be associated with a non-marketplace environment such as an informational (e.g., search engine) or social networking environment.

The payment system 122 provides a number of payment services and functions to users. The payment system 122 allows users to accumulate value (e.g., in a commercial currency, such as the U.S. dollar, or a proprietary currency, such as points, miles, or other forms of currency provide by a private entity) in their accounts, and then later to redeem the accumulated value for products (e.g., goods or services) that are made available via the publication system 120 or elsewhere on the network 104. The payment system 122 also facilitates payments from a payment mechanism (e.g., a bank account, PayPal™, or credit card) for purchases of items via any type and form of a network-based marketplace.

While the publication system 120 and the payment system 122 are shown in FIG. 1 to both form part of the networked system 102, it will be appreciated that, in alternative embodiments, the payment system 122 may form part of a payment service that is separate and distinct from the networked system 102. Additionally, while the example network architecture 100 of FIG. 1 employs a client-server architecture, a skilled artisan will recognize that the present disclosure is not limited to such an architecture. The example network architecture 100 can equally well find application in, for example, a distributed or peer-to-peer architecture system. The publication system 120 and payment system 122 may also be implemented as standalone systems or standalone software programs operating under separate hardware platforms, which do not necessarily have networking capabilities.

Referring now to FIG. 2, an example block diagram illustrating multiple components that, in one embodiment, are provided within the publication system 120 of the networked system 102 is shown. In this embodiment, the publication system 120 is a marketplace system where items (e.g., services or goods, such as, parts) may be offered for sale. The items may comprise digital goods (e.g., currency, license rights) or physical goods. The publication system 120 may be hosted on dedicated or shared server machines (not shown) that are communicatively coupled to enable communications between the server machines. The multiple components themselves are communicatively coupled (e.g., via appropriate interfaces), either directly or indirectly, to each other and to various data sources, to allow information to be passed between the components or to allow the components to share and access common data. Furthermore, the components may access the one or more databases 126 via the one or more database servers 124.

The publication system 120 provides a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the publication system 120 may comprise at least one publication engine 202 and one or more auction engines 204 that support auction-format listing and price setting mechanisms (e.g., English, Dutch, Chinese, Double, Reverse auctions, etc.).

A pricing engine 206 supports various price listing formats. One such format is a fixed-price listing format (e.g., the traditional classified advertisement-type listing or a catalog listing). Another format comprises a buyout-type listing. Buyout-type listings (e.g., the Buy-It-Now (BIN) technology developed by eBay Inc., of San Jose, Calif.) may be offered in conjunction with auction-format listings and allow a buyer to purchase goods or services, which are also being offered for sale via an auction, for a fixed price that is typically higher than a starting price of an auction for an item.

A store engine 208 allows a seller to group listings within a “virtual” store, which may be branded and otherwise personalized by and for the seller. Such a virtual store may also offer promotions, incentives, and features that are specific and personalized to the seller. In one example, the seller may offer a plurality of items as Buy-It-Now items in the virtual store, offer a plurality of items for auction, or a combination of both.

A reputation engine 210 allows users that transact, utilizing the networked system 102, to establish, build, and maintain reputations. These reputations may be made available and published to potential trading partners. Because the publication system 120 supports person-to-person trading between unknown entities, in accordance with one embodiment, users may otherwise have no history or other reference information whereby the trustworthiness and credibility of potential trading partners may be assessed. The reputation engine 210 allows a user, for example through feedback provided by one or more other transaction partners, to establish a reputation within the network-based marketplace over time. Other potential trading partners may then reference the reputation for purposes of assessing credibility and trustworthiness.

Navigation of the network-based marketplace may be facilitated by a navigation engine 212. For example, a browse module (not shown) of the navigation engine 212 allows users to browse various category, catalog, or inventory data structures according to which listings may be classified within the publication system 120. Various other navigation applications within the navigation engine 212 may be provided to supplement the browsing applications.

In order to make listings available via the networked system 102 as visually informing and attractive as possible, the publication system 120 may include an imaging engine 214 that enables users to upload images for inclusion within publications and to incorporate images within viewed listings. The imaging engine 214 may also receive image data from a user as a search query and utilize the image data to identify an item depicted or described by the image data.

A listing creation engine 216 allows users (e.g., sellers) to conveniently author listings of items. In one embodiment, the listings pertain to goods or services that a user (e.g., a seller) wishes to transact via the publication system 120. In other embodiments, a user may create a listing that is an advertisement or other form of publication.

A listing management engine 218 allows the users to manage such listings. Specifically, where a particular user has authored or published a large number of listings, the management of such listings may present a challenge. The listing management engine 218 provides a number of features (e.g., auto-relisting, inventory level monitors, etc.) to assist the user in managing such listings.

A post-listing management engine 220 also assists users with a number of activities that typically occur post-listing. For example, upon completion of a transaction facilitated by the one or more auction engines 204, a seller may wish to leave feedback regarding a particular buyer. To this end, the post-listing management engine 220 provides an interface to the reputation engine 210 allowing the seller to conveniently provide feedback regarding multiple buyers to the reputation engine 210. Another post-listing action may be shipping of sold items whereby the post-listing management engine 220 may assist in printing shipping labels, estimating shipping costs, and suggesting shipping carriers.

A search engine 222 performs searches for publications in the networked system 102 that match a query. In example embodiments, the search engine 222 comprises a search module (not shown) that enables keyword searches of publications published via the publication system 120. In a further embodiment, the search engine 222 may take an image received by the imaging engine 214 as an input for conducting a search. The search engine 222 takes the query input and determines a plurality of matches from the networked system 102 (e.g., publications stored in the database 126). It is noted that the functions of the search engine 222 may be combined with the navigation engine 212.

A parts engine 224 manages an enhanced shopping mechanism that allows buyers to search for and purchase parts or items of a larger product using visual browsing and schematics. In some embodiments, the parts engine 224 may work in conjunction with the navigation engine 212, the search engine 222, and/or the imaging engine 214. The operations of the parts engine 224 will be discussed in more detail below.

Although the various components of the publication system 120 have been defined in terms of a variety of individual modules and engines, a skilled artisan will recognize that many of the components can be combined or organized in other ways and that not all modules or engines need to be present or implemented in accordance with example embodiments. Furthermore, not all components of the marketplace system 120 have been included in FIG. 2. In general, components, protocols, structures, and techniques not directly related to functions of exemplary embodiments (e.g., dispute resolution engine, loyalty promotion engine, personalization engines, etc.) have not been shown or discussed in detail. The description given herein simply provides a variety of exemplary embodiments to aid the reader in an understanding of the systems and methods used herein.

In order to illustrate embodiments of the present invention, example embodiments are discussed herein with reference to vehicles and shopping for items or parts for the vehicles. However, example embodiments may be applicable to searching for items or parts for other products.

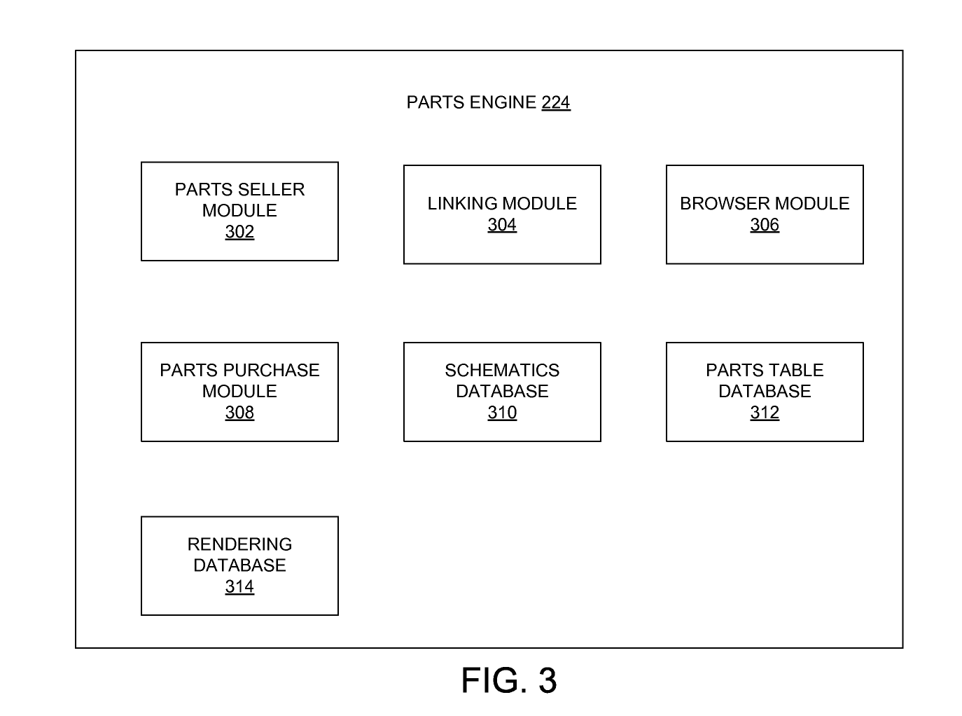

Referring to FIG. 3, the parts engine 224 is shown in more detail. The parts engine 224 maintains a database of OEM schematics and provides a browse experience to drill down to a particular item or part for purchase. To enable these operations, the parts engine 224 may comprise a parts seller module 302, a linking module 304, a browser module 306, a parts purchase module 308, a schematics database 310, a parts table database 312, and a rendering database 314, which may be communicatively coupled together.

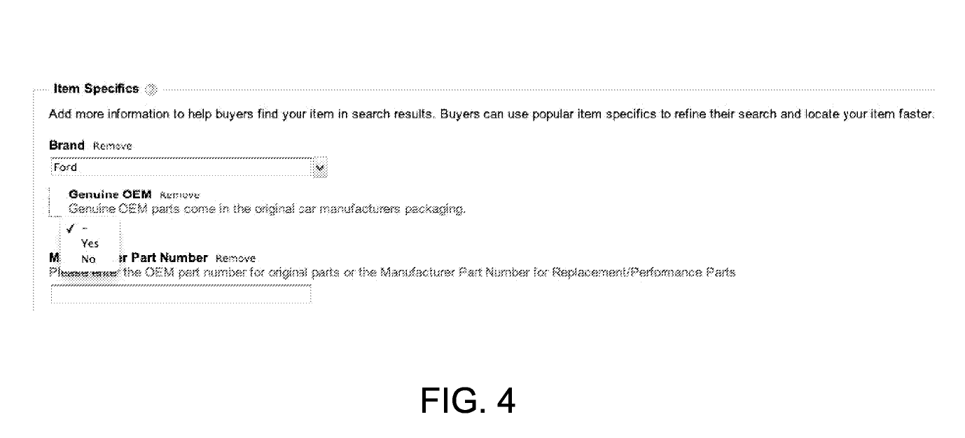

The parts seller module 302 provides a parts form or user interface that allows the seller to enter information regarding a part that the seller is offering to sell when creating a listing for the part or item. An example of the parts form is shown in FIG. 4. The seller may identify a brand, make, model, or engine type of the part. The seller may also identify whether the part is a genuine OEM part, a lower-cost generic part, or a high performance version of the OEM part. Additionally, the seller may enter a part number for the part. The part number may be universal for a particular part for a particular manufacturer. In some embodiments, some or all of the operations of the parts seller module 302 may be provided by the listing creation engine 216.

Referring back to FIG. 3, the linking module 304 takes the information inputted into the parts form and links the information to a particular OEM schematic that is stored in the schematic database 310. The OEM schematic is typically generic by a manufacturer of the parts. As such, the linking module 304 takes the brand information along with the part number and accesses a table in the parts table database 312 to determine a matching OEM schematic from the schematics database 310. This OEM schematic may then be linked to the listing that is created by the seller for selling the part. For example, the listing may provide a diagram reference or Uniform Resource Locator (URL) that accesses the matching OEM schematic.

The browser module 306 manages a browse search mode for a part. In example embodiments, a buyer may start with an identification of their vehicle for which they want to find a part. In some cases, their vehicle may have been previously set up with the publication system 120 and associated with their user profile. Alternatively, the buyer may enter make and model information or start with a brand/make component and visually drill down until they reach their vehicle and the desired part. In some embodiments, some or all of the operations of the browser module 306 may be embodied in the search engine 222 and/or navigation engine 212.

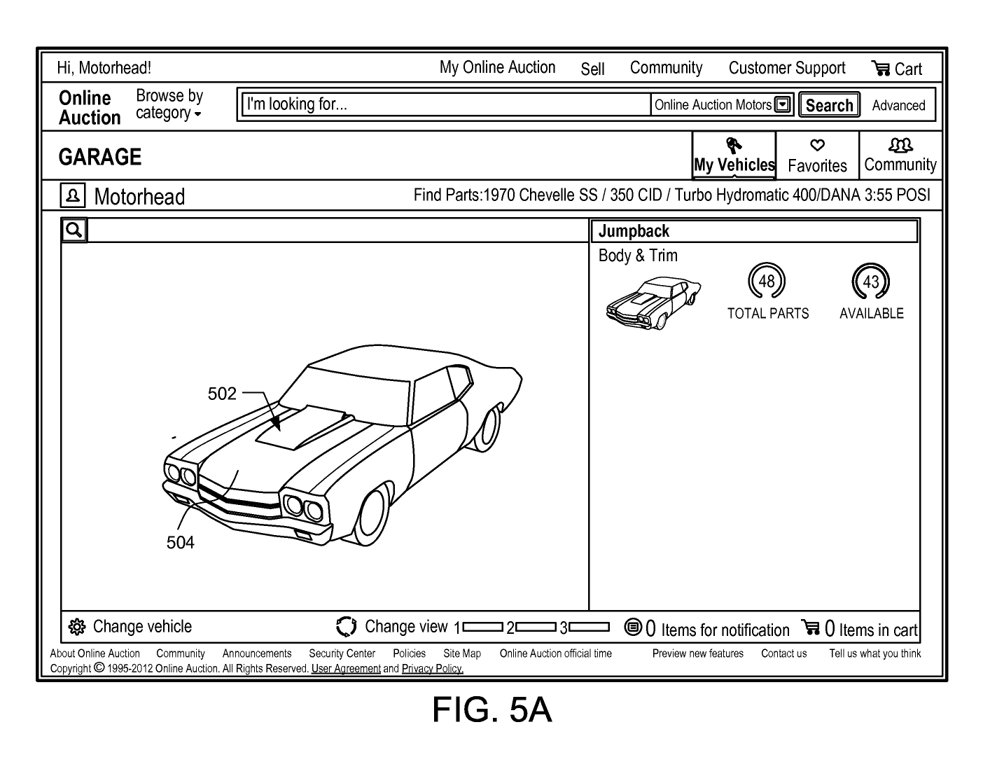

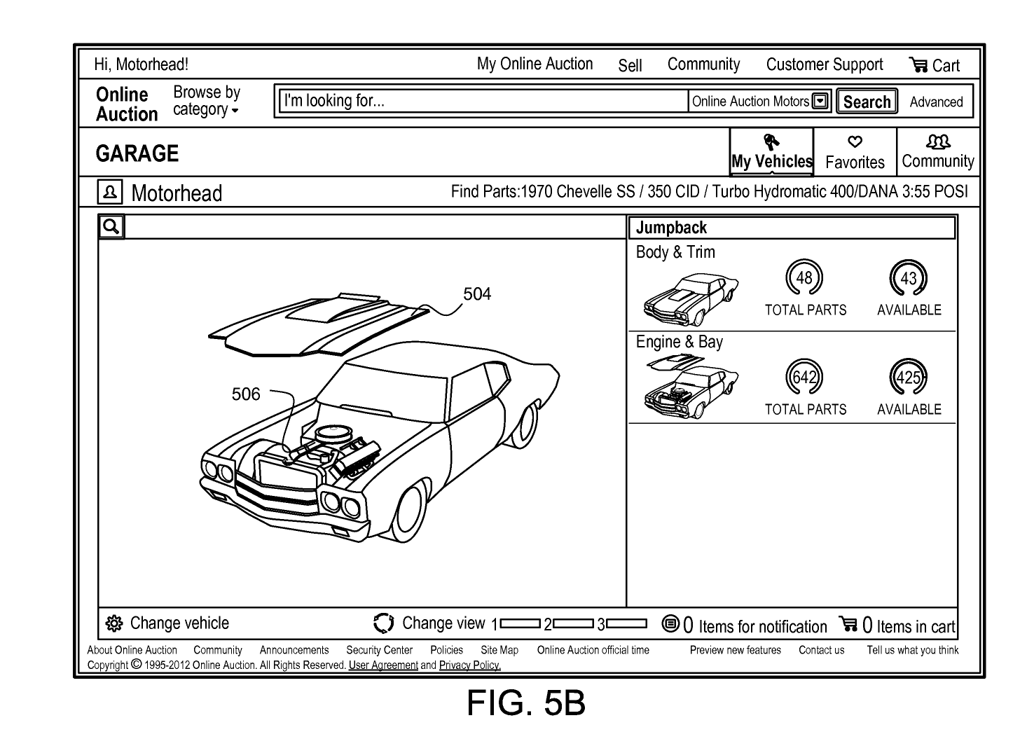

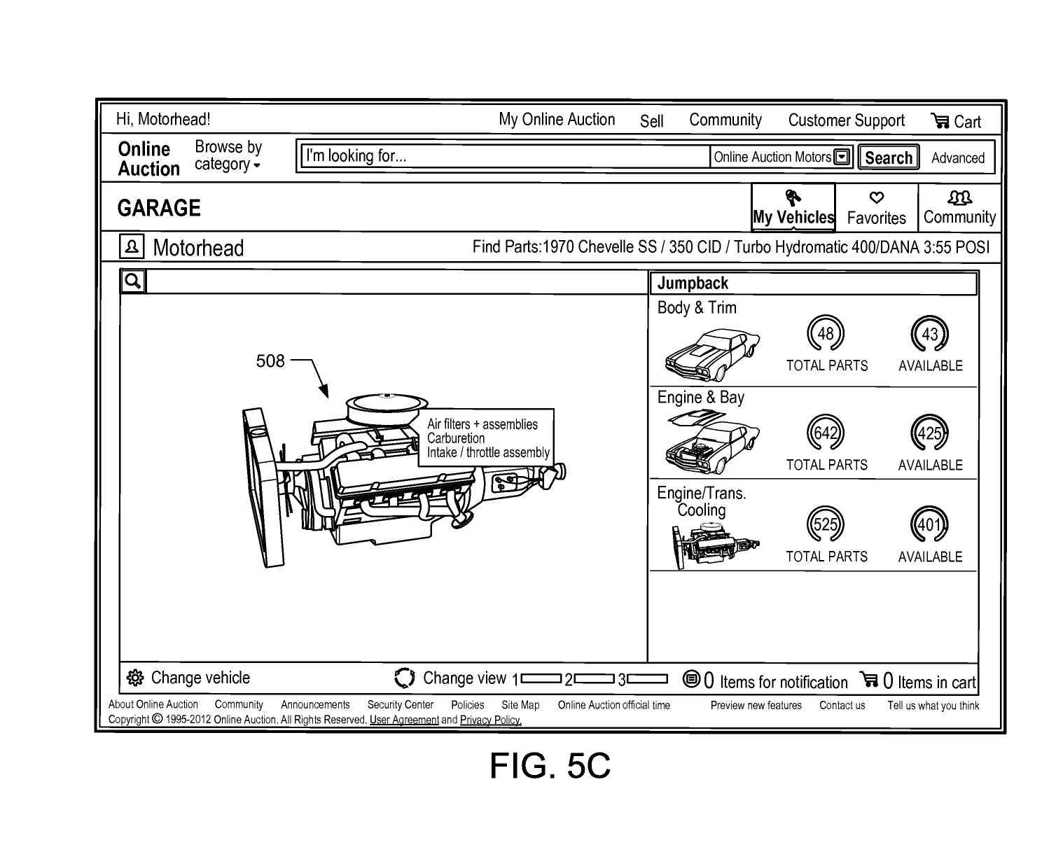

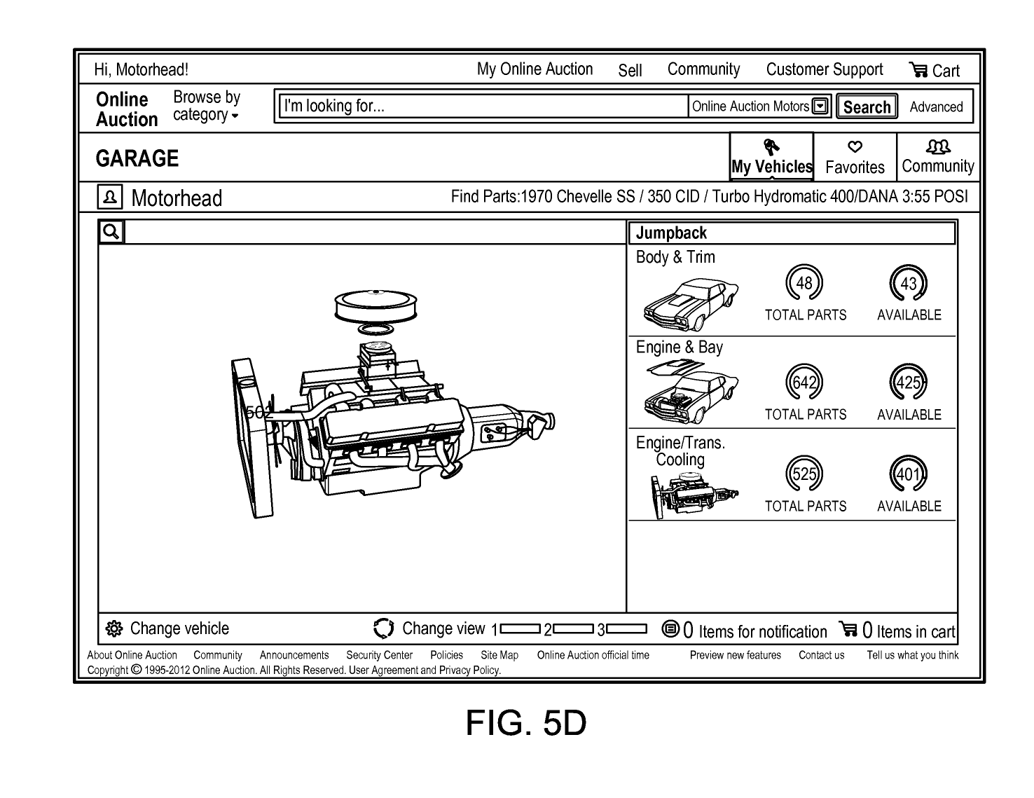

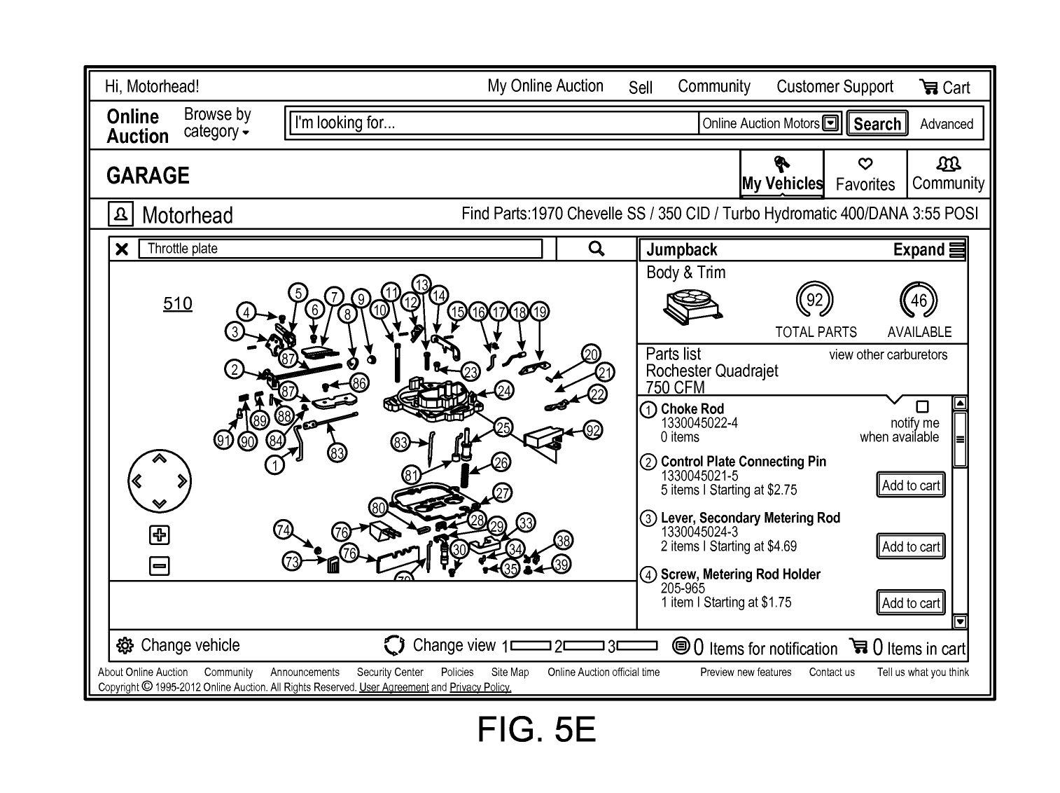

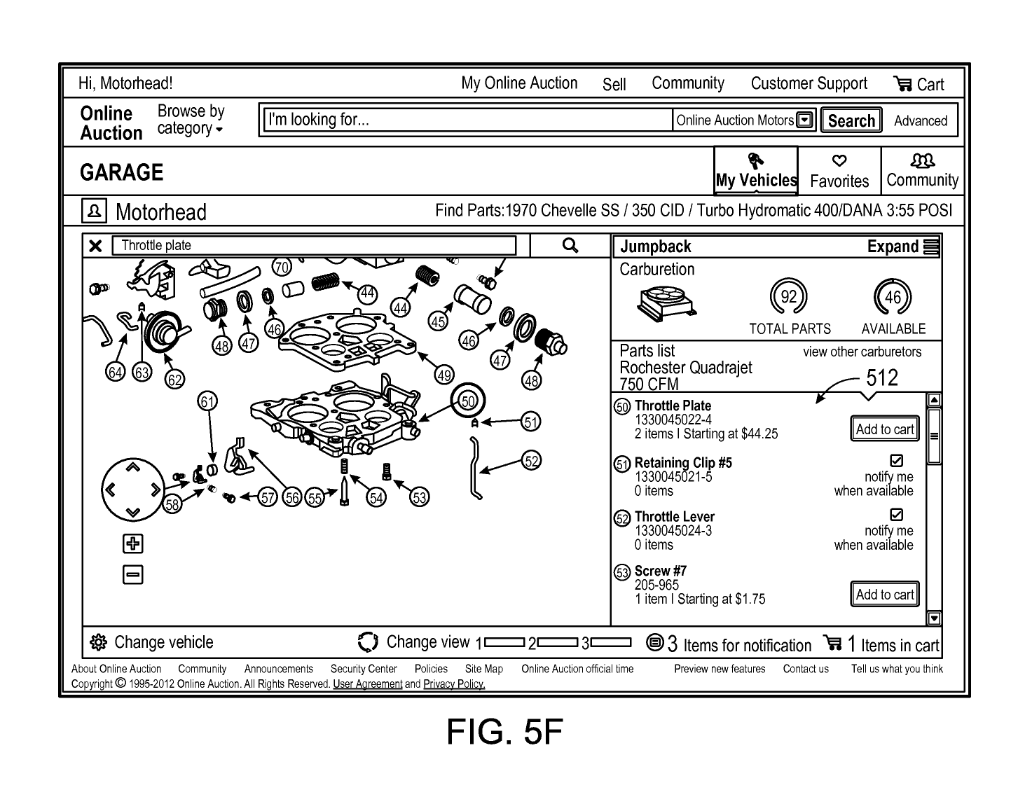

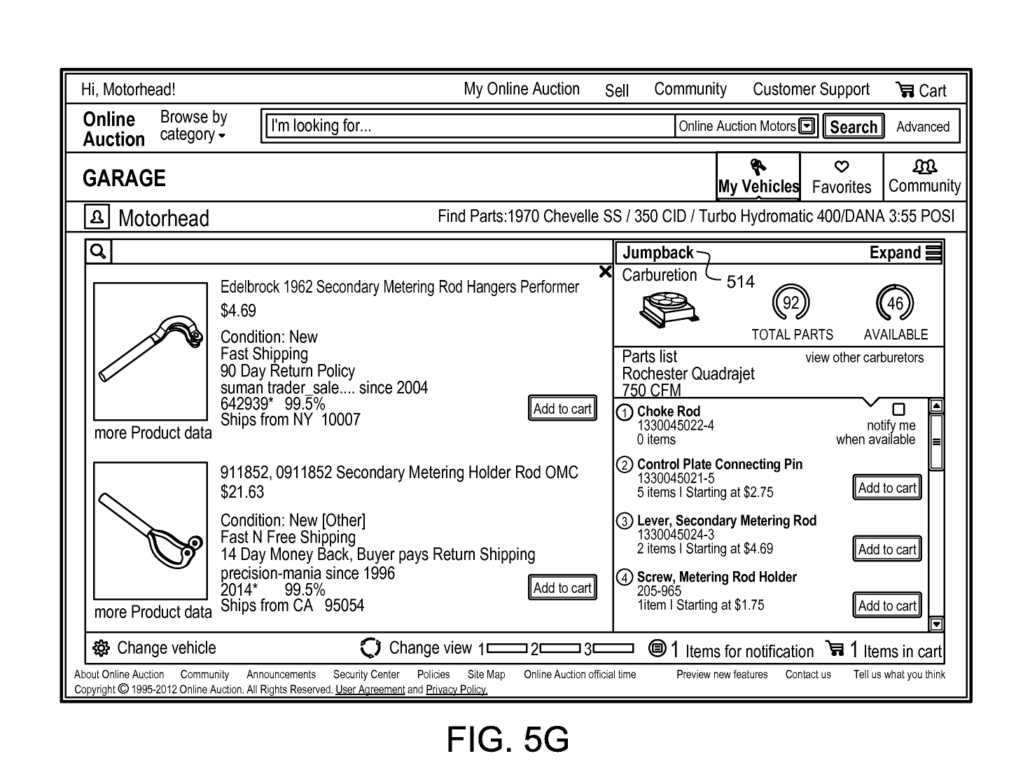

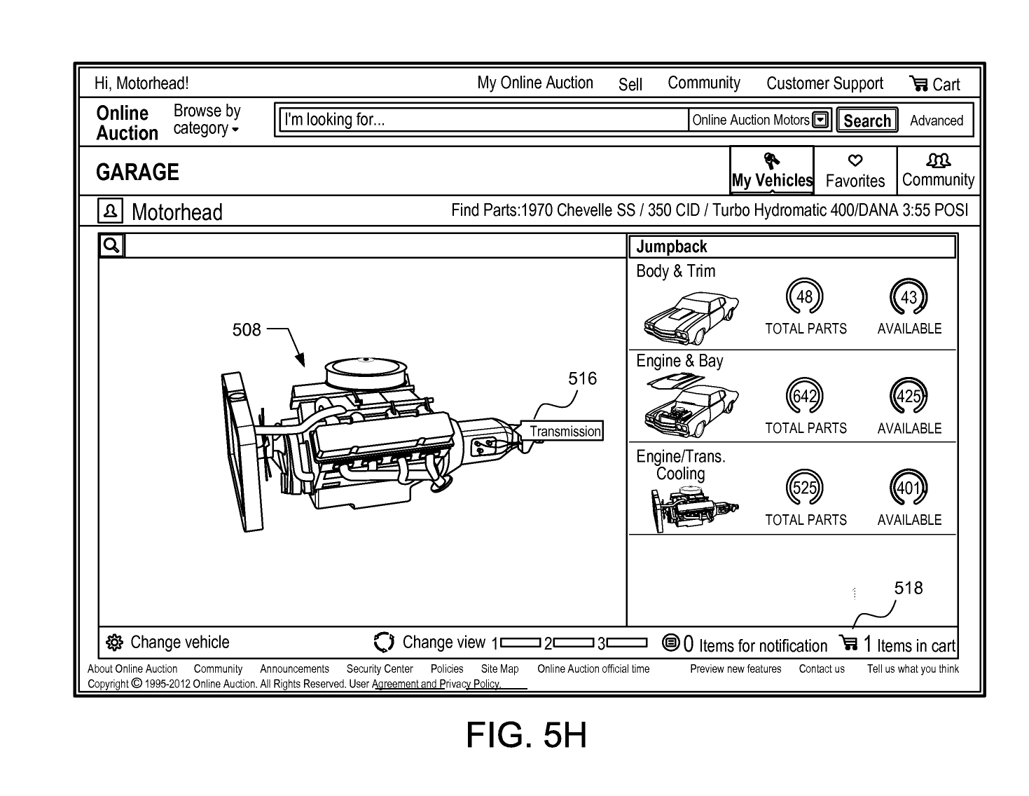

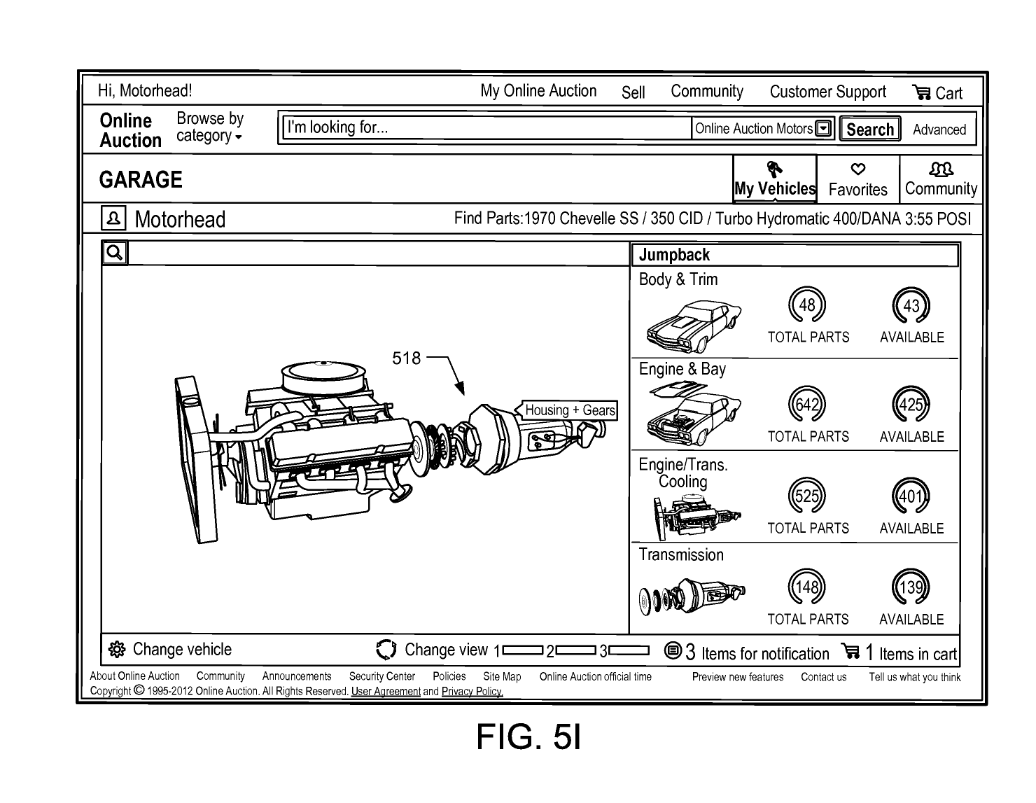

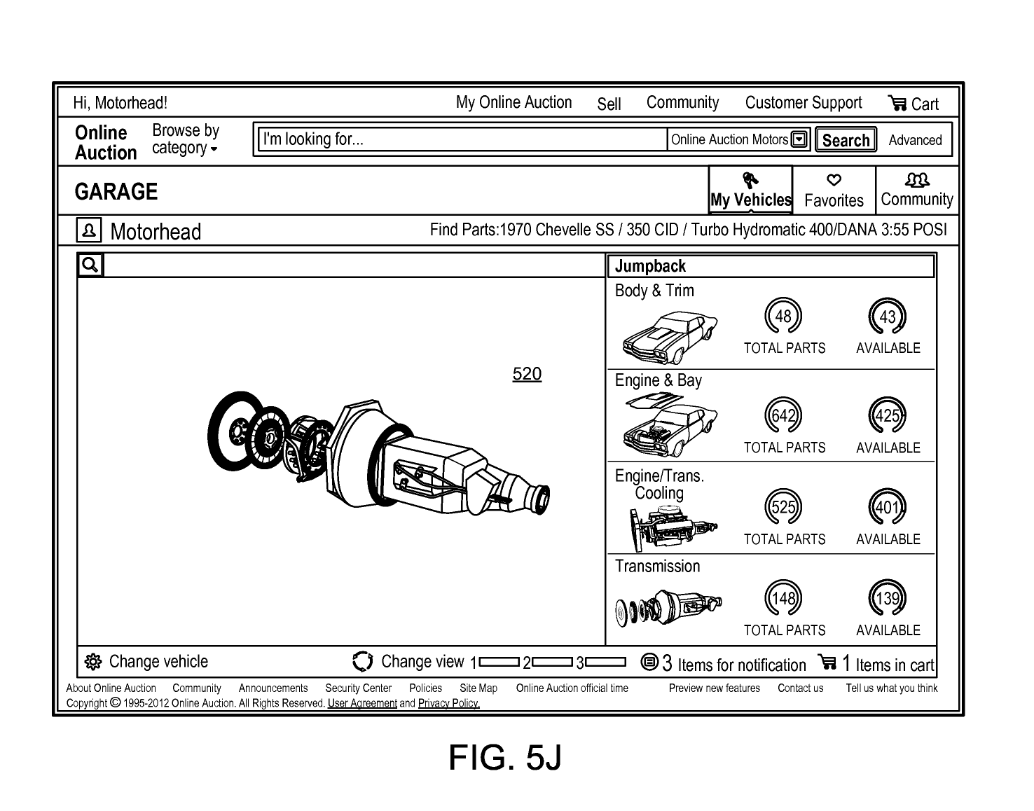

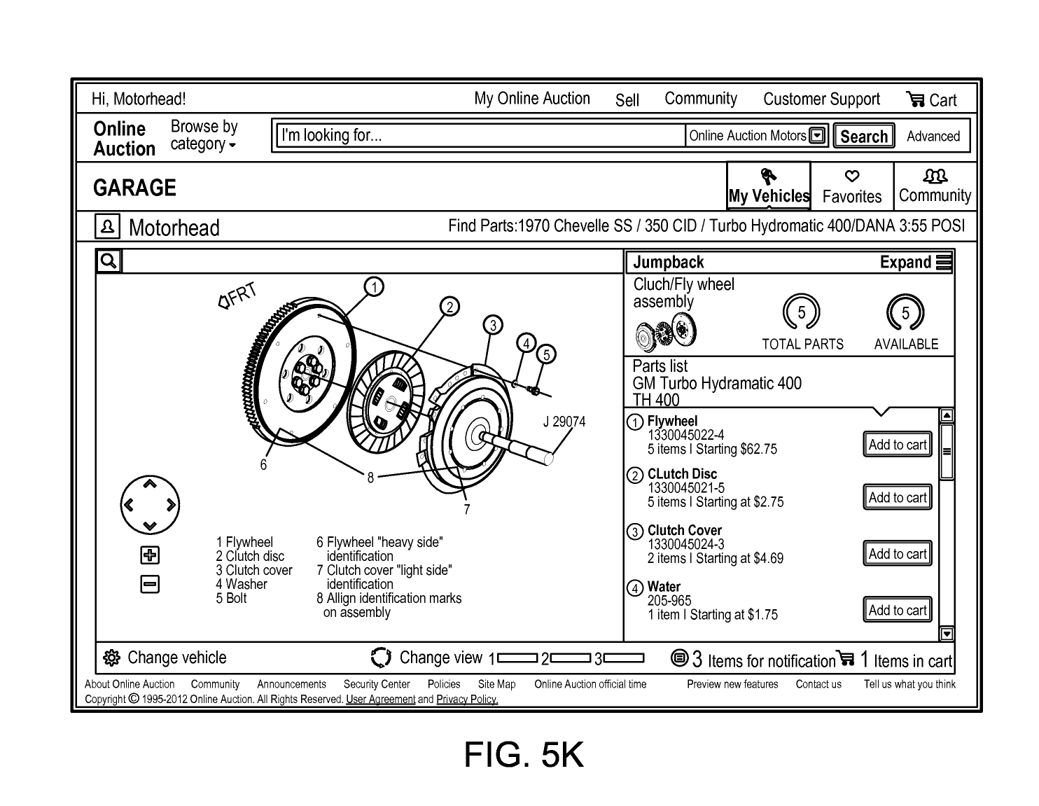

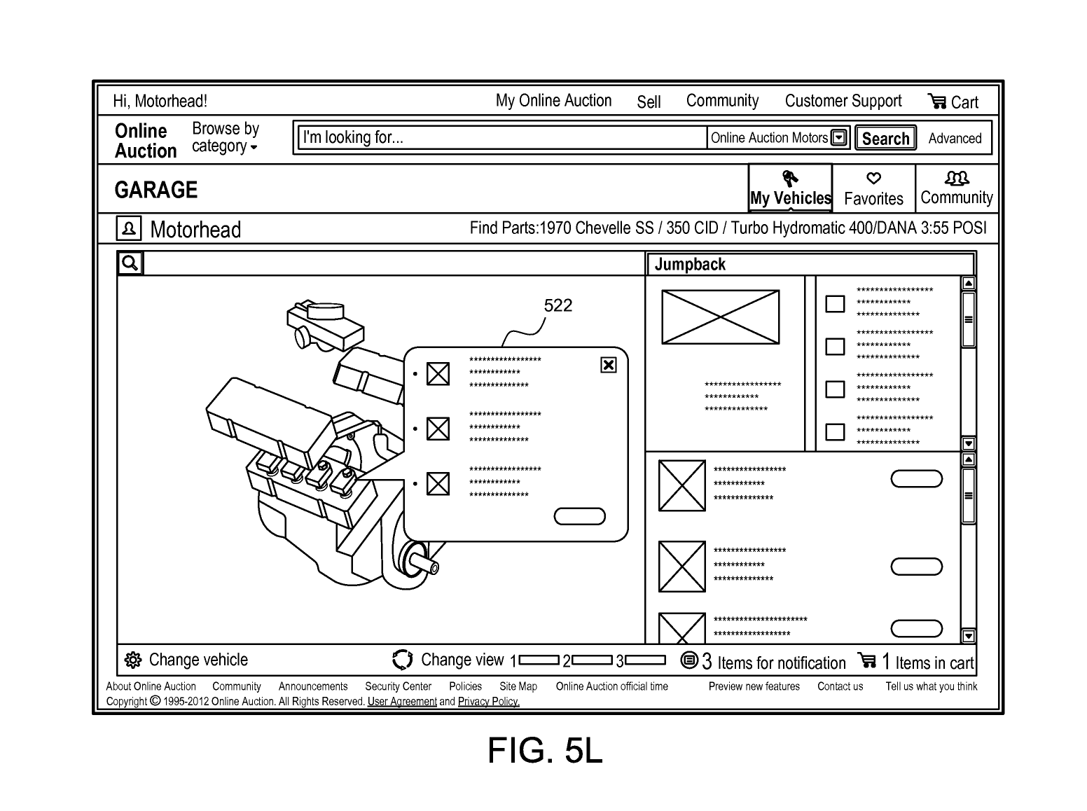

For example, a buyer may go to “My Vehicles” in their “Garage” (e.g., an online location where you store vehicles that you own) on the publication system 120. The user may click on the vehicle they want to find parts for, and the browser module 306 takes the buyer down a browse path. An example screenshot of the selected vehicle is shown in FIG. 5A. As shown, the browse path may start with a rendering of the buyer's car (e.g., 1970 Chevelle) that is obtained from the rendering database 314. As the buyer drills down, the buyer may select a hood area 502 on the car in FIG. 5A, and an animation may be presented to remove a hood 504 from the rest of the car. With the hood 504 removed, a motor 506 is exposed as presented in FIG. 5B. Next, the buyer may select, on FIG. 5B, an engine area on the rendering. This will cause the screenshot of FIG. 5C to be presented which includes a rendering of an engine 508. A selection on a carburetor area may cause an expansion of the engine rendering as shown in FIG. 5D.

A further selection of a carburetor may present an OEM schematic 510 shown in FIG. 5E if the OEM schematic 510 of the carburetor exists. In example embodiments, the browser module 306 may determine whether the OEM schematic 510 exists for a portion of the product by accessing the schematics database 310 and performing a search for the corresponding OEM schematic 510. In other embodiments, a link may be associated (e.g., embedded) in the rendering (e.g., of FIG. 5D) that is activated when the buyer selects on a portion of the rendering that is associated with the link. If no OEM schematic exists, a rendering of the portion (from the rendering database 314) may be presented. If the OEM schematic 510 exists, the view is switched from a rendering to the OEM schematic 510. The OEM schematic 510 may be called/accessed on demand when the buyer clicks on the link (e.g., a part or portion of a rendering). The OEM schematic 510 may show highlighted parts and numbers that correspond to the parts. These highlighted parts may be items that the publication system 120 has in inventory, and parts that are not highlighted may not have inventory on the publication system 120. When the buyer clicks on or views a portion of a part(s) or number corresponding to the part (e.g., part #50 in FIG. 5F) or group of parts, the browser module 306 provides a scrollable list 512 on a side of the user interface for the selected part(s). Information on the part(s) may be provided on the list 512.

In some embodiments, parts on the OEM schematic 512 may be “hot linked” to listings (e.g., inventory) on the publication system 120. For example, if the buyer clicks on a part or corresponding number for the part, one or more listings may be presented to the buyer (e.g., as a popup or as a new list that replaces the list 512).

From the list 512, the buyer can, in one embodiment, select an “add to cart” button to add the part into their shopping cart (e.g., from a favorite or preferred seller based on preferences in a buyer profile). In example embodiments, the parts purchase module 308 (FIG. 3) adds the part to the buyer's cart.

Alternatively, the buyer may click on the “add to cart” button and a list of sellers or a listings of items for sale on the publication system 120 may be presented, by the parts purchase module 308, from which the buyer may select to purchase a part (e.g., shown in FIG. 5G). In one embodiment, the schematic 510 is replaced with the listings of items for sale. The list of sellers or the listings of items for sale on the publication system 120 may be ordered by favorite seller or other preferences of the buyer as indicated, for example, in their user profile.

In yet other embodiments, if the buyer does not have preferences identified in their user profile, the list of sellers or listings of items for sale on the publication system 120 may be based on best match, top sellers, best price, highest ratings, free shipping, closest seller, or any other attribute. In some embodiments, the buyer may then select the part to add to their cart without the system sending the buyer to a shopping cart page (e.g., selecting the part will add the part to their shopping cart but the buyer remains on their current user interface). This allows the buyer to continue shopping for related, corresponding, or additional parts.

In example embodiments, the sellers may be identified as authorized OEM sellers, for example, with a logo. As such, each listing of items for sale may have a seller tag that specifies if the listing is from an authorized OEM seller. In some cases, the OEM schematics may only be available for use in listings of authorized OEM sellers.

After the buyer adds the part to their shopping cart, the buyer can step back out to the list 512, a prior schematic, or one of the renderings (prior to the availability of schematics) to continue shopping for other parts. In one embodiment, the buyer may select from a jumpback section 514 of the user interface to go to another area of the car or to one of the previous renderings or schematics. FIG. 5H shows a screenshot where the buyer has stepped back out to the rendering of the engine 508 and is now interested in a transmission 516. As shown, a part (e.g., corresponding to the carburetor) is already in the buyer's cart 518.

The buyer may select an area on the transmission 516 and an expansion of the transmission 516 may be presented to the buyer as shown in FIG. SI. More specifically, the transmission 516 is expanded (e.g., in an animated manner) to present a “housing and gears” area 518. Based on the buyer selecting the “housing and gears” area 518 on the user interface shown in FIG. SI, a “housing and gears” rendering 520 may be presented as shown in FIG. 5J. In response to a selection of a clutch/flywheel assembly area, an OEM schematic of the assembly is presented as shown in FIG. 5K. From here, the buyer may select a part (e.g., select a listing of the part for sale from the publication system 120 or simply select “add to cart”) and add the part to their shopping cart.

FIG. 5L illustrates an alternative embodiment for providing parts for purchase. Instead of presenting parts and/or listings for parts in a list on the side of the user interface or replacing the schematic with the listing for parts, the parts or listing from the publication system 120 may be shown in a popup window 522 or bubble corresponding to the selected area. The buyer can then decide from which seller or listing to purchase and add the part to their shopping cart.

In some embodiments, the parts purchase module 308 may indicate a number of parts the buyer should add to the cart when multiples of the part may be needed. The number may be indicated in the list, for example. In some embodiments, the seller may provide reference to the diagram parts number and quantity recommended. This quantity recommended is then used to indicate when multiple parts may be needed.

In some cases, there are groups of parts that are recommended to be bought together. This information may be stored in the parts table database 312. When the buyer selects one part, the browser module 306 may access the parts table database 312 and determine other (e.g., related) parts that are typically purchased with the selected part. As such, a group of parts may be highlighted together. For example, the part that the buyer selected may be highlighted in a dark color (e.g., dark green) and the rest of the group may be highlighted in a lighter version of the color (e.g., lighter green) to give the buyer an idea that these other parts are some things that they should buy together. As a result, the seller may directly promote other parts in the group or assembly, and allow the buyer to add all the parts needed to the cart and perform a simplified checkout.

In further embodiments, the buyer may be given the option to purchase the OEM part or an equivalent part. For example, the list 512 or search results presented to the buyer may include a category of parts that are high performance versions of the OEM part and/or a category of low-cost, generic alternatives for the OEM part in addition to the OEM parts. Alternatively, the list 512 may present the OEM parts and provide a selectable indication that high performance and/or low-cost, generic parts are may be available. In some embodiments, the parts table database 312 may indicate a relationship between the original OEM part number, the high performance part number, and/or a low-cost, generic version that is accessed when the part is selected on the schematic.

For parts that are not currently available, the buyer may select to be notified if the part later becomes available at the publication system 120. In example embodiments, the publication system 120 maintains a record of these requests for notifications and may notify OEM sellers that a certain number of people are looking for a particular part. The seller may then decide to list that particular part on the publication system 120.

While embodiments have been discussed with respect to purchasing parts for vehicles, example embodiments may be used for the sale of other items, such as parts for appliances or firearms. Further still, while OEM schematics are discussed above, it is noted that a schematic may simply be a curated grouping of items with associated data. As such, a schematic may be an image that has been curated. For example, the schematic may be an image of a celebrity wearing particular clothing items, eyewear, and jewelry that has been identified or otherwise tagged. A buyer may then select items (e.g., sunglasses, watch, coat) on the schematic and be presented with an option to buy these items on the publication system 120.

In further embodiments, the browse module 306 reviews statistics and other data of sold items to derive parts that are bought together. This derived information may be provided to the sellers so that the sellers can recommend parts that should be bought together. As such, the recommendations (e.g., groups of parts) may be determined based on data and not by algorithm/patterns.

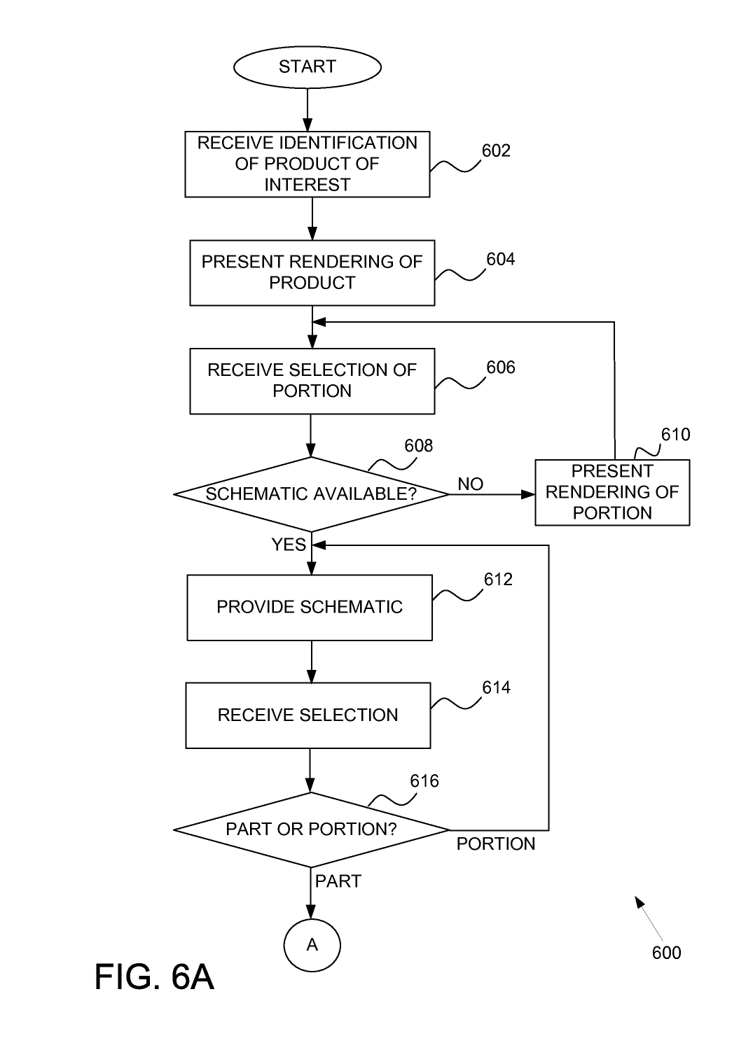

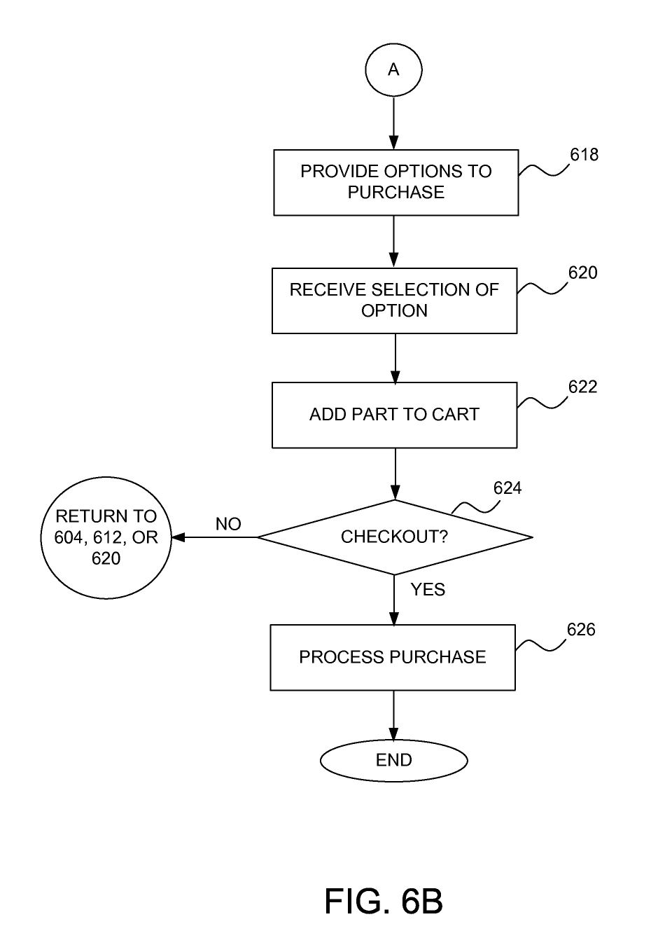

FIGS. 6A and 6B are flow diagrams of an example method 600 for enhancing parts shopping. The operations of the method 600 may be performed by the parts engine 224. In operation 602, an identification of a product of interest is received. For example, a buyer may go to “My Vehicles” in their “Garage” (e.g., an online location where you store vehicles that you own) on the publication system 120. The user may click on the vehicle they want to find parts for. Alternatively, the user may enter search terms (e.g., “1970 Chevelle”) for the product of interest. The indication (e.g., the click or search terms) are received by the browser module 306.

In operation 604, a rendering of the product of interest in presented. The rendering may be a graphical depiction of the product of interest. In example embodiments, the browser module 306 accesses a rendering of the product from the rendering database 314 and provides the rendering for display on a device of the user.

In operation 606, a selection of a portion of the rendering is received. In example embodiments, the buyer may select a portion in order to drill down on the portion of the product to arrive at a particular part to purchase. In one example, the user may click on an area of the product for which a part is desired. For example, the buyer may select a hood area on the car.

In operation 608, a determination is made as to whether a schematic is available for the selected portion of the product. In example embodiments, the browser module 306 may determine whether the schematic exists for the portion of the product by accessing a schematics database 310 and performing a search for the corresponding schematic. If a schematic is not available, then a rendering of the portion is provided in operation 610. However, if the schematic of the portion is available, then the schematic is retrieved from the schematic database 310 and presented in operation 612. In one embodiment, the schematic is an OEM schematic.

It is noted that in some embodiments, a schematic may be available from a top level. That is, the identification of the product of interest (operation 602) may trigger presentation of the schematic (operation 612) when a schematic is available. In these embodiments, renderings (e.g., diagrams not provided by an OEM) may not be required (operations 604 and 606 not needed).

In operation 614, a further selection is received by the browser module 306. The further selection may be a selection of a portion of the schematic or a particular part in the schematic. A determination is performed in operation 616 to determine whether the selection is of the portion or the particular part. If the selection is of the portion of the schematic, then the method 600 returns to operation 612 where a further schematic (of the selected portion) is provided for display.

If the selection is of a particular part, then purchase options are provided in operation 618. In one embodiment, the browser module 306 provides a scrollable list of available parts for sale on a side of the user interface for the selected part. In an alternative embodiment, the list may replace the schematic or be presented in a popup window. The list may comprise listings of items/parts available for purchase from the publication system 120.

In operation 620, a selection of a purchase option is received. For example, the parts purchase module 308 receives a selection of one of the listings from the list. In some cases, the selection may cause the listing to be presented to the user so that the user can see the details of the listing. If the selection includes an indication to add the part to a shopping cart, the part is added into the user's shopping cart in operation 622.

In operation 624, a determination is made as to whether to checkout. If the user indicates to checkout, then the purchase is processed in operation 626. However, if the user wants to search for other parts, then the user can jumpback returning to, for example, operations 604 or 612, or continue to add parts to the shopping cart by returning to operation 620.

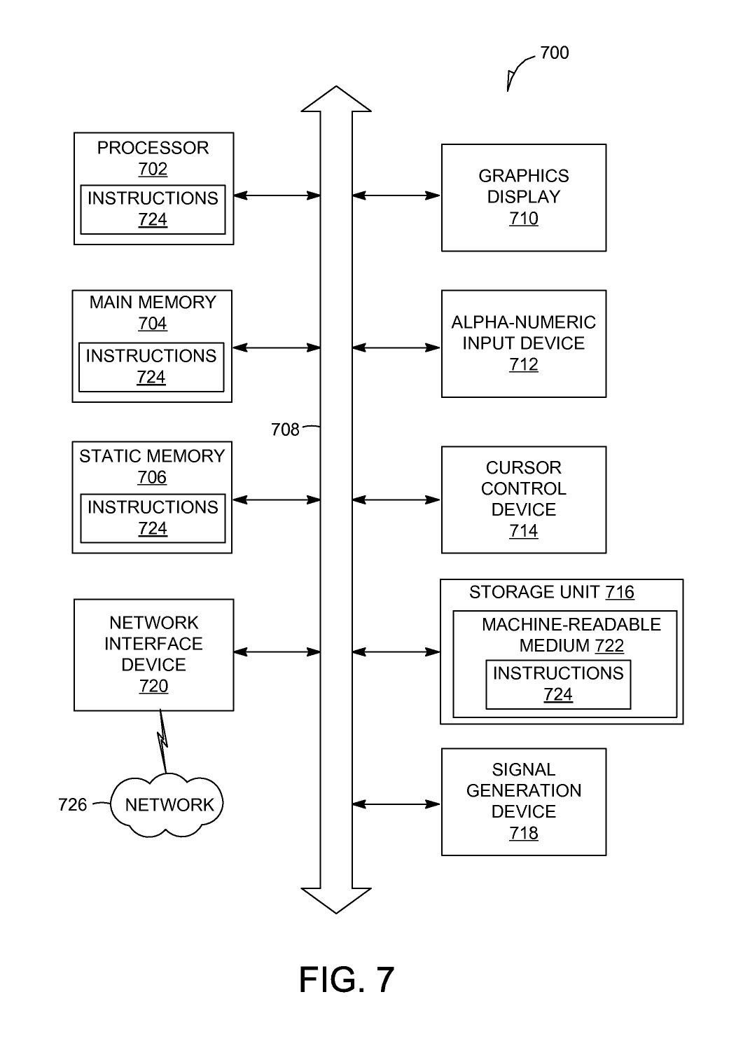

FIG. 7 is a block diagram illustrating components of a machine 700, according to some example embodiments, able to read instructions from a machine-readable medium (e.g., a machine-readable storage medium) and perform any one or more of the methodologies discussed herein. Specifically, FIG. 7 shows a diagrammatic representation of the machine 700 in the example form of a computer system and within which instructions 724 (e.g., software, a program, an application, an applet, an app, or other executable code) for causing the machine 700 to perform any one or more of the methodologies discussed herein may be executed. In alternative embodiments, the machine 700 operates as a standalone device or may be connected (e.g., networked) to other machines. In a networked deployment, the machine 700 may operate in the capacity of a server machine or a client machine in a server-client network environment, or as a peer machine in a peer-to-peer (or distributed) network environment. The machine 700 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 724, sequentially or otherwise, that specify actions to be taken by that machine. Further, while only a single machine is illustrated, the term “machine” shall also be taken to include a collection of machines that individually or jointly execute the instructions 724 to perform any one or more of the methodologies discussed herein.

The machine 700 includes a processor 702 (e.g., a central processing unit (CPU), a graphics processing unit (GPU), a digital signal processor (DSP), an application-specific integrated circuit (ASIC), a radio-frequency integrated circuit (RFIC), or any suitable combination thereof), a main memory 704, and a static memory 706, which are configured to communicate with each other via a bus 708. The machine 700 may further include a graphics display 710 (e.g., a plasma display panel (PDP), a light emitting diode (LED) display, a liquid crystal display (LCD), a projector, or a cathode ray tube (CRT)). The machine 700 may also include an alphanumeric input device 712 (e.g., a keyboard), a cursor control device 714 (e.g., a mouse, a touchpad, a trackball, a joystick, a motion sensor, or other pointing instrument), a storage unit 716, a signal generation device 718 (e.g., a speaker), and a network interface device 720.

The storage unit 716 includes a machine-readable medium 722 on which is stored the instructions 724 embodying any one or more of the methodologies or functions described herein. The instructions 724 may also reside, completely or at least partially, within the main memory 704, within the processor 702 (e.g., within the processor's cache memory), or both, during execution thereof by the machine 700. Accordingly, the main memory 704 and the processor 702 may be considered as machine-readable media. The instructions 724 may be transmitted or received over a network 726 via the network interface device 720.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 722 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions for execution by a machine (e.g., machine 700), such that the instructions, when executed by one or more processors of the machine (e.g., processor 702), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Furthermore, the tangible machine-readable medium is non-transitory in that it does not embody a propagating signal. However, labeling the tangible machine-readable medium as “non-transitory” should not be construed to mean that the medium is incapable of movement—the medium should be considered as being transportable from one physical location to another. Additionally, since the machine-readable medium is tangible, the medium may be considered to be a machine-readable device.

The instructions 724 may further be transmitted or received over a communications network 726 using a transmission medium via the network interface device 720 and utilizing any one of a number of well-known transfer protocols (e.g., HTTP). Examples of communication networks include a local area network (LAN), a wide area network (WAN), the Internet, mobile telephone networks, plain old telephone service (POTS) networks, and wireless data networks (e.g., WiFi, LTE, and WiMAX networks). The term “transmission medium” shall be taken to include any intangible medium that is capable of storing, encoding, or carrying instructions for execution by the machine, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field-programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Although an overview of the inventive subject matter has been described with reference to specific example embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A non-transitory machine-readable storage medium in communication with at least one processor, the non-transitory machine-readable storage medium storing instructions which, when executed by the at least one processor of a machine, cause the machine to perform operations comprising:
causing a user interface to present a diagram of a product to a user;
receiving a selection of a portion of the product displayed on the user interface;
causing presentation of a schematic from a schematic database corresponding to the selected portion on the user interface, the schematic indicating selectable items;
receiving a selection of an item of the selectable items on the schematic; and
providing an option to purchase the selected item in response to the selection of the item.

2. The non-transitory machine-readable storage medium of claim 1, wherein the operations further comprise receiving a selection of the option to purchase the selected item.

3. The non-transitory machine-readable storage medium of claim 2, wherein the operations further comprise placing the selected item into a shopping cart of the user without redirecting the user to a shopping cart page.

4. The non-transitory machine-readable storage medium of claim 1, wherein the providing the option comprises presenting a list of one or more listings of the item available for purchase on a portion of the user interface.

5. The non-transitory machine-readable storage medium of claim 1, wherein the providing the option comprises replacing the schematic with a list of one or more listings of the item available for purchase.

6. The non-transitory machine-readable storage medium of claim 1, wherein the providing the option comprises causing a popup window to display a list of one or more listings of the item available for purchase.

7. The non-transitory machine-readable storage medium of claim 1, wherein the operations further comprise:
determining related items to the selected item, the related items being a part of a group of one or more items frequently purchased with the selected item; and
visually distinguishing the related items on the schematic from the selected item to indicate that the related items are frequently purchased with the selected item.

8. The non-transitory machine-readable storage medium of claim 1, wherein the operations further comprise visually distinguishing items that are available for purchase from items that are not available for purchase on the schematic.

9. The non-transitory machine-readable storage medium of claim 1, wherein the diagram of the product comprises a rendering of the product or a higher level schematic of the product.

10. The non-transitory machine-readable storage medium of claim 1, wherein the operations further comprise:
providing a seller parts form for entering information regarding the item that a seller is offering to sell, the seller parts form being used to create a listing of the item available for purchase; and
linking the information to the schematic that is stored in the schematic database.

11. The non-transitory machine-readable storage medium of claim 1, wherein the providing an option to purchase the selected item further comprises providing an option to purchase an original equipment manufacturer (OEM) item or an equivalent item, the equivalent item being one of a low-cost version of the OEM item or a high performance version of the OEM item.

12. A method comprising:
causing a user interface to present a diagram of a product to a user;
receiving a selection of a portion of the product displayed on the user interface;
causing, using a hardware processor, presentation of a schematic from a schematic database corresponding to the selected portion on the user interface, the schematic indicating selectable items;
receiving a selection of an item of the selectable items on the schematic; and
providing an option to purchase the selected item in response to the selection of the item.

13. The method of claim 12, further comprising:
receiving a selection of the option to purchase the selected item; and
placing the selected item into a shopping cart of the user without redirecting the user to a shopping cart page.

14. The method of claim 12, wherein the providing the option comprises presenting a list of one or more listings of the item available for purchase on a portion of the user interface.

15. The method of claim 12, wherein the providing the option comprises replacing the schematic with a list of one or more listings of the item available for purchase.

16. The method of claim 12, wherein the providing the option comprises causing a popup window to display a list of one or more listings of the item available for purchase.

17. The method of claim 12, further comprising:
providing a seller parts form for entering information regarding the item that a seller is offering to sell, the seller parts form being used to create a listing of the item available for purchase; and
linking the information to the schematic that is stored in the schematic database.

18. A system comprising:
a hardware processor; and
a browser module to:
cause a user interface to present a diagram of a product to a user,
receive a selection of a portion of the product displayed on the user interface,
cause presentation of a schematic from a schematic database corresponding to the selected portion on the user interface, the schematic indicating selectable items,
receive a selection of an item of the selectable items on the schematic, and
provide an option to purchase the selected item in response to the selection of the item.

19. The system of claim 18, further comprising a parts purchase module to:
receive a selection of the option to purchase the selected item; and
place the selected item into a shopping cart of the user without redirecting the user to a shopping cart page.

20. The system of claim 18, further comprising:
a parts seller module to provide a seller parts form for entering information regarding the item that a seller is offering to sell, the seller parts form being used to create a listing of the item available for purchase; and
a linking module to link the information to the schematic that is stored in the schematic database.
